(19) United States
(12) Patent Application Publication
(10) Pub. No.: US 2023/0173442 A1
(43) Pub. Date: Jun. 8, 2023

(54) MIXING IMPELLERS FOR SEALANT CARTRIDGES

(71) Applicant: PRC-Desoto International, Inc., Sylmar, CA (US)

(72) Inventors: Paul Kuchinski, Valley Village, CA (US); Goldi Singh, Chino Hills, CA (US); Oscar Santillan, Camarillo, CA (US)

(73) Assignee: PRC-Desoto International, Inc., Sylmar, CA (US)

(21) Appl. No.: 17/995,486

(22) PCT Filed: Apr. 5, 2021
(86) PCT No.: PCT/US2021/025792

§ 371 Date: Oct. 5, 2022

Related U.S. Application Data
(60) Provisional application No. 63/005,527, filed on Apr. 6, 2020.

(51) Int. Cl. B01F 31/40; B01F 27/1123; B01F 27/113; B01F 27/2122; B01F 27/88; B01F 33/501; B01F 35/32; B01F 35/71; B01F 35/75

(52) U.S. Cl. CPC B01F 31/40; B01F 27/1123; B01F 27/113; B01F 27/2122; B01F 27/88; B01F 33/50112; B01F 35/3202; B01F 35/7137; B01F 35/754251; B01F 2101/36

(57) ABSTRACT

A mixing impeller (10) for mixing a sealant inside a cartridge (1) is disclosed. The mixing impeller (10) comprises a central hub (11) and at least two mixing arms (20) extending radially outward from the central hub (11). Each of the mixing arms (20) may include a leading edge (24), a trailing edge (26), and a wiping edge (28) extending circumferentially between a leading tip (25) of the leading edge (24) and a trailing edge transition (27) of the trailing edge (26). The wiping edge (28) may have an arc length defining a wiping edge (28) angle, the leading tip (25) may be circumferentially offset in a direction of rotation of the mixing impeller (10) defining a leading edge (24) angle to provide a forward swept configuration, and the wiping edge (28) angle may be greater than the leading edge (24) angle. A sealant cartridge (1) and mixing impeller (10) assembly is also disclosed.

### CROSS-REFERENCE TO RELATED APPLICATION

This application claims the benefit of U.S. Provisional Patent Application Ser. No. 63/005,527 filed Apr. 6, 2020, which is incorporated herein by reference.

### FIELD OF THE INVENTION

The present invention relates to mixing impellers for sealant cartridges.

### BACKGROUND INFORMATION

Conventional adhesive and sealant mixers, such as those utilized in the aerospace industry, are used to mix separate components together in a cartridge. The cartridges are mounted on a reciprocating platform, and a rotating dasher rod with an impeller is forced through the inside of the cartridge to mix the adhesive or sealant components together. However, many sealant formulations are sensitive to proper mixing ratios and require good homogeneity when mixed together.

On occasion, users may make mistakes or not follow instructions due to time constraints, training deficiencies, or other errors. As a result of improper mixing, the sealant or adhesive may experience substandard performance. This results in a rejection by quality control and the incurrence of additional expense to correct the problem. The mixing impellers of the present invention work to reduce user errors by blending the sealant or adhesive more efficiently, thereby preventing quality problems that may normally occur using standard impellers.

### SUMMARY OF THE INVENTION

The present invention provides a mixing impeller for mixing a sealant inside a cartridge. The mixing impeller comprises a central hub and at least two mixing arms extending radially outward from the central hub. Each of the mixing arms includes a leading edge, a trailing edge, and a wiping edge extending circumferentially between a leading tip of the leading edge and a trailing edge transition of the trailing edge. The wiping edge has an arc length defining a wiping edge angle, the leading tip is circumferentially offset in a direction of rotation of the mixing impeller defining a leading edge angle, and a ratio of the wiping edge angle to the leading edge angle is greater than 1:1.

The present invention also provides a mixing impeller for mixing a sealant inside a cartridge. The mixing impeller comprises a central hub, and at least two mixing arms extending radially outward from the central hub. Each of the mixing arms includes a leading edge with a leading tip at a radial outermost portion thereof, a trailing edge with a trailing edge transition at a radial outermost position thereof, and a mixing arm tip between the leading tip and the trailing edge transition. The mixing arm tip has a thickness measured along an axial direction of the mixing impeller that is less than an arc length of the mixing arm tip measured from the leading tip to the trailing edge transition.

The present invention further provides a sealant cartridge and mixing impeller assembly comprising a generally cylindrical sealant mixing cartridge, and a mixing impeller inside the sealant mixing cartridge. The mixing impeller comprises a central hub, and at least two mixing arms extending radially outward from the central hub. Each of the mixing arms includes a leading edge, a trailing edge, and a wiping edge extending circumferentially between a leading tip of the leading edge and a trailing edge transition of the trailing edge, wherein the wiping edge has an arc length defining a wiping edge angle W, the leading tip is circumferentially offset in a direction of rotation of the mixing impeller defining a leading edge angle, and a ratio of the wiping edge angle to the leading edge angle is greater than 1:1.

### BRIEF DESCRIPTION OF THE DRAWINGS

FIG. 1 is a side view of a sealant cartridge including a mixing impeller of the present invention.

FIGS. 2 and 3 are bottom isometric and top isometric views of a mixing impeller of the present invention.

FIG. 4 is a top view and FIG. 5 is a side view of the mixing impeller of FIGS. 2 and 3.

FIG. 6 is a side sectional view taken through line 6-6 of FIG. 5.

FIGS. 7-9 are top isometric, top and side views of another mixing impeller of the present invention.

FIG. 10 is a side sectional view taken through line 10-10 of FIG. 9.

FIGS. 11-13 are top isometric, top and side views of another mixing impeller of the present invention.

FIG. 14 is a side sectional view taken through line 14-14 of FIG. 13.

FIGS. 15 and 16 are bottom isometric and top isometric views of another mixing impeller of the present invention.

FIG. 17 is a top view and FIG. 18 is a side view of the mixing impeller of FIGS. 15 and 16.

FIG. 19 is a side sectional view taken through line 19-19 of FIG. 18.

FIG. 20 is a bottom isometric view, FIG. 21 is a bottom view, FIG. 22 is a top view and FIG. 23 is a side view of another mixing impeller of the present invention.

### DETAILED DESCRIPTION OF THE INVENTION

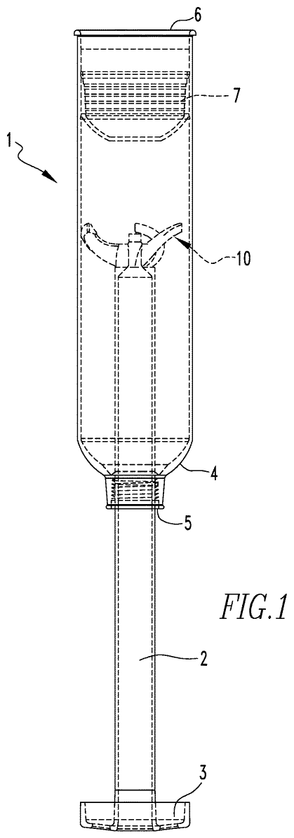

As shown in FIG. 1, an adhesive or sealant cartridge 1 has a dasher rod 2 rotatably and slidably movable within the adhesive/sealant cartridge 1. A lower spindle attachment disk 3 is integrally formed with the bottom of the dasher rod 2 and engages a standard rotating spindle (not shown) in order to rotate the dasher rod 2 and spindle attachment disk 3. The adhesive/sealant cartridge 1 has a domed lower end 4 with a cartridge discharge opening 5. The cartridge 1 also has an open upper end 6 through which an upper plunger 7 with a dome-shaped interior surface is inserted inside the cartridge 1. The volume inside the cartridge 1 between the domed lower end 4 and upper plunger 7 defines a mixing volume inside the cartridge 1 that contains adhesive or sealant formulations that require mixing prior to their usage. As more fully described below, the adhesive and sealant compositions may comprise any formulations known to those skilled in the art. The dasher rod 2 extends through the cartridge discharge opening 5 into the mixing volume of the cartridge 1 and has a mixing impeller 10 mounted on a top end thereof.

The mixer sealant cartridge 1 may be used to mix two components of adhesive or sealant formulations that are initially introduced into the cartridge 1. Mixing of the components in the cartridge 1 is achieved by stroking the rotating dasher rod 2 and impeller 10 mounted thereon from one end of the cartridge 1 to the other. The dasher rod 2 is inserted in the cartridge 1 through the front or dispensing end 5 of the cartridge 1, and engages the impeller 10, which may be initially provided inside the cartridge 1 and may remain in the cartridge 1 after the mixing operation is completed. When mixing is completed, the dasher rod 2 may be disengaged from the impeller 10, and the dasher rod 2 may be removed through the dispensing end 5 of the cartridge 1.

The mixing impeller 10 may be forced through the adhesive or sealant formulation contained in the cartridge 1 through the relative vertical movement of the cartridge 1 in relation to the vertically stationary mixing impeller 10 and dasher rod 2. The stroke distance inside the cartridge 1 is defined by the distance the impeller 10 moves between the lower end 4 and the upper plunger 7. Typical stroke distances may range from 2 to 8 inches, for example, from 3 to 6 inches, depending on the size of a particular cartridge.

As used herein, the term “sealant” includes both sealant and adhesive formulations. The sealant formulations contained in the cartridge 1 may comprise a two-component (“2K”) composition. As used herein, a “two-component composition” (or “2K composition”) refers to an adhesive or sealant composition in which at least a portion of the reactive components readily react and cure without activation from an external energy source, such as at ambient or slightly thermal conditions, when mixed. One skilled in the art understands that the two components of the adhesive or sealant composition are stored separately from each other and mixed just prior to application of the composition.

The first component of the 2K composition may comprise one or more epoxy-containing compounds, such as epoxies, polysulfides, polythioethers and the like. The adhesive or sealant composition further comprises a second component that chemically reacts with the first component, such as manganese dioxide, dichromate polysulfide, epoxy and the like. As used herein, the term “cure”, “cured” or similar terms, as used in connection with the adhesive composition described herein, means that at least a portion of the components that form the adhesive or sealant composition are crosslinked to form an adhesive layer or bond. The second component may be referred to as a curing agent, hardener and/or cross-linker.

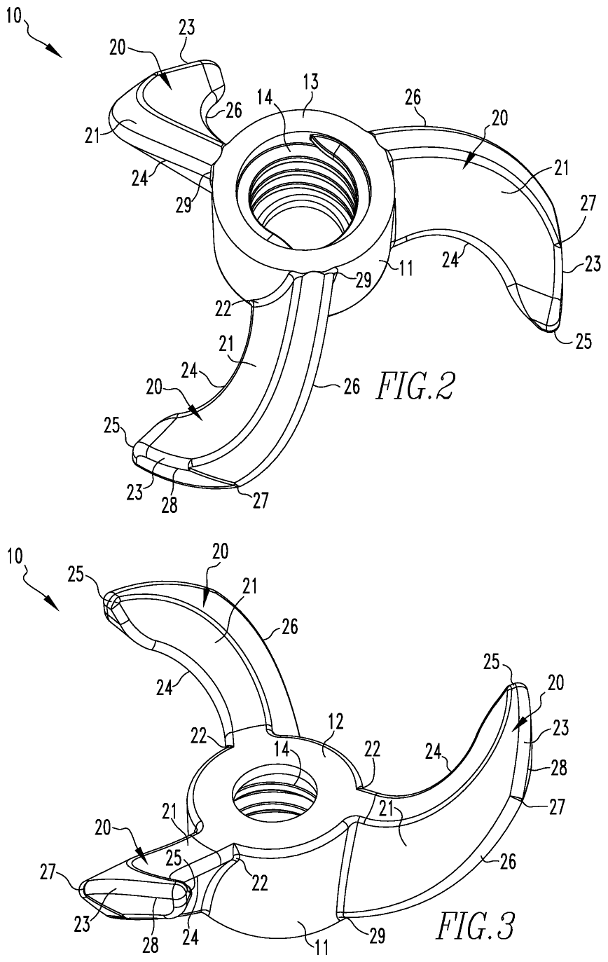

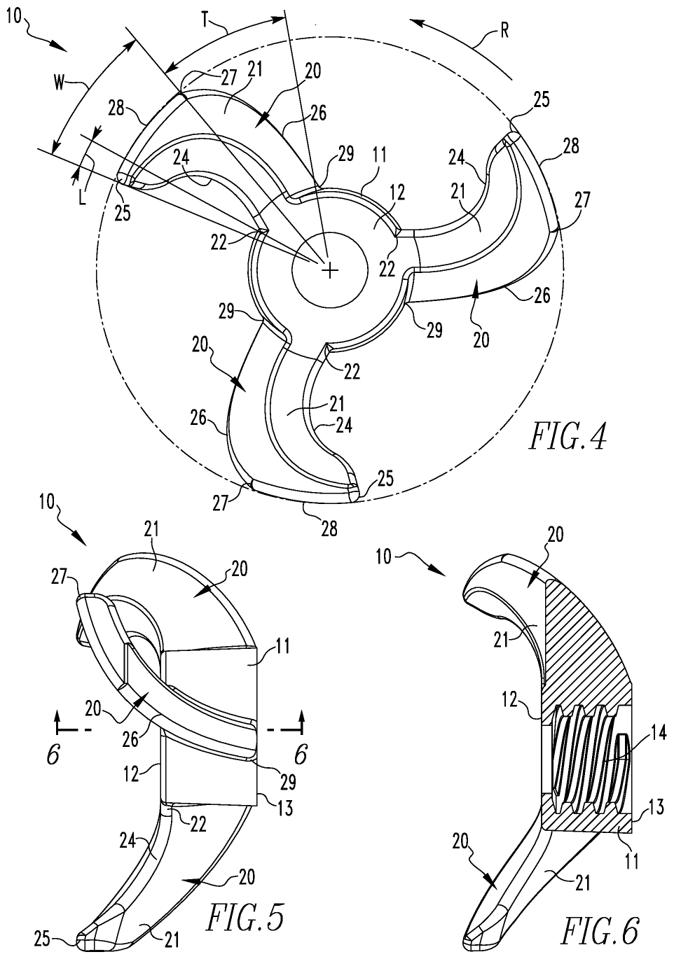

FIGS. 2-6 illustrate details of the mixing impeller 10. The mixing impeller 10 includes a central hub 11 having a top face 12 and a bottom face 13. A threaded hole 14 extends through the hub 11 from the top face 12 to the bottom face 13. As further shown in FIGS. 2-6, the mixing impeller 10 includes multiple mixing arms 20. Three mixing arms 20 are shown in FIGS. 2-6; however, any other suitable number of mixing arms may be used such as two, four, five or more mixing arms. Each mixing arm 20 includes a body 21 connected to the hub 11 at one end and having a tip 23 at the other end. Each mixing arm 20 includes a leading edge 24 and a leading tip 25, and a trailing edge 26 having a transition 27 in the region between the outer end of the trailing edge 26 and the tip 23. The tip 23 forms a wiping edge 28 at the radial outermost portion of the mixing arm 20. A leading edge base fillet 22 is provided in the region where the inward portion of the leading edge 24 intersects the hub 11. A trailing edge base fillet 29 is provided in the region where the inward portion of the trailing edge 26 intersects the hub 11.

As shown in FIG. 4, the leading edge 24 of the mixing impeller 10 has a concave shape, and the trailing edge 26 has a convex shape. The leading tip 25 of the leading edge 24 is circumferentially offset in a direction of rotation R of the mixing impeller 10 in relation to the base fillet 22 at the intersection between the leading edge 24 and the hub 11. The circumferential offset of the leading tip 25 is defined by a leading edge angle L, as shown in FIG. 4. The transition 27 between the trailing edge 26 and the tip 23 of the mixing impeller 10 is circumferentially offset in the direction of rotation R of the mixing impeller 10 in relation to the base fillet 29 located at the intersection of the trailing edge 26 and the hub 11. This circumferential offset of the trailing edge transition 27 is defined as the trailing edge angle T, as shown in FIG. 4. At the tip 23 of the mixing arm 20, the wiping edge 28 of the tip extends circumferentially between the leading tip 25 and trailing edge transition 27 along an arc length, which is defined as a wiping edge angle W in FIG. 4.

The trailing edge angle T may be greater than the leading edge angle L, e.g., the ratio of T:L may be greater than 1.05:1, or greater than 1.1:1, or greater than 1.5:1, or greater than 2:1. For example, the ratio of T:L may range from 1.05:1 to 10:1, or from 1:1 to 5:1, or from 2:1 to 4:1. The wiping edge angle W of the wiping edge 28, which corresponds to its arc length, may typically be larger than the leading edge angle L of the leading tip 25, e.g., the ratio of W:L may be greater than 1:1. For example, the ratio of W:L may be greater than 1.05:1, or greater than 1.1:1, or greater than 1.5:1, or greater than 2:1, or may be from 1.1:1 to 10:1, or from 1.5:1 to 5:1, or from 2:1 to 4:1. Furthermore, the wiping edge angle W may be approximately the same as the trailing edge angle T of the trailing edge transition 27, or may be less than or greater than the trailing edge angle T. For example, the ratio of W:T may be from 1:2 to 2:1, or from 1.5:1 to 1:1.5, or from 1.2:1 to 1:1.2, or may be greater than or equal to 1:1, or greater than 1.1:1, or greater than 1.2:1.

The leading edge angle L of the leading tip 25 may typically range from 1 to 20°, for example, from 2 to 15°, or from 3 to 10°. The trailing edge angle T of the trailing edge transition 27 may typically be greater than 5° or greater than 10°, for example, from 8° to 45°, or from 10° to 40°, or from 15° to 30°. The wiping edge angle W of the wiping edge 28 may typically range from 5° to 45°, for example, from 10° to 40°, or from 15° to 30°.

As shown in FIG. 4, the concave leading edge 24 may have a radius of curvature along at least a portion thereof that is less than the radius of the mixing impeller 10. The convex trailing edge 26 may include at least a portion having a radius of curvature that is less than the radius of the mixing impeller 10, and may also have a portion having a radius of curvature that is greater than the radius of the mixing impeller 10.

As shown most clearly in FIGS. 2 and 3, the tip 23 of the mixing arm 20 has a thickness measured along an axial direction of the mixing impeller 10 that may be shorter than the arc length of the wiping edge 28, as measured by the wiping edge angle W. The axial thickness of the tip 23 of the mixing impeller 10 may typically be at least 20 percent less than the arc length W of the tip 23, for example, at least 20 percent less, or at least 50 percent less, or at least 100 percent less.

While not intending to be bound by any particular theory, the shapes of the mixing arms 20 as shown in FIGS. 2-6 may improve efficiency and mixing of sealants within the cartridge 1 by providing high flow rate with low shearing forces. The base and catalyst may be blended together by producing a greater amount of flow of material inside the cartridge. The increased flow may blend together, or homogenize, the two different materials in less time. The gradual angle change of the blade from the leading edges towards the center may lessen the shear rate to reduce the chance for damaging sensitive additives in some sealants.

The shape of the mixing arms 20 may also conform to the curved shapes of the cartridge dome 4 and plunger 7 in a minimum amount of space so that when all the mixed sealant is eventually dispensed from the cartridge the minimal amount of sealant remains inside the cartridge. This avoids excess sealant remaining inside the cartridge 1 after dispensing. Thus, the plunger 7 travel distance is maximized such that the plunger 7 can travel all the way to the dome 4 to completely dispense the sealant.

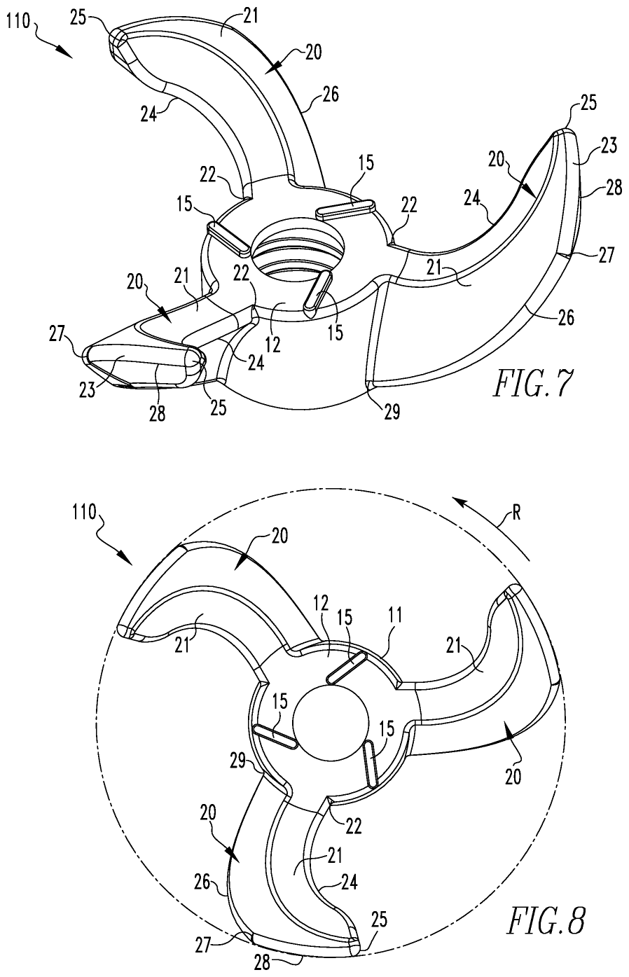

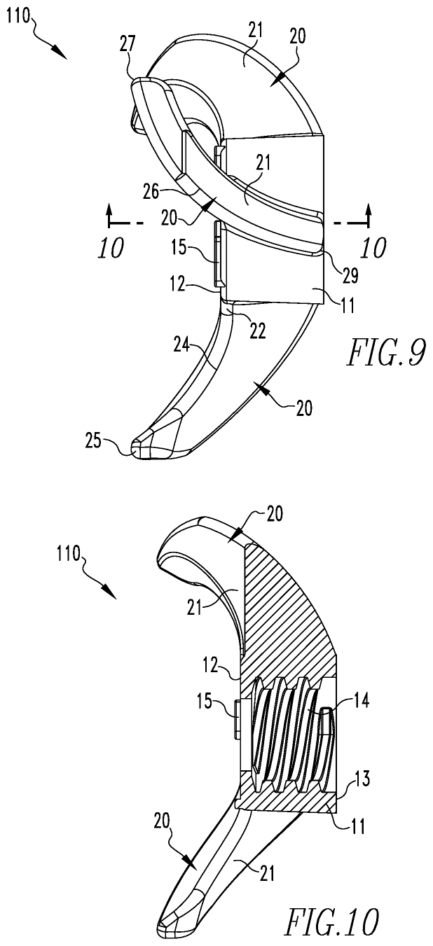

FIGS. 7-10 illustrate another mixing impeller 110 of the present invention similar to that shown in FIGS. 2-6, with the addition of angled mixing bars 15 projecting upwardly from the top face 12 of the hub 11. Each angled mixing bar 15 extends radially outward from the central hole of the hub 11 to the outer edge of the hub 11 at an angle opposite to the direction of rotation R of the mixing impeller 110. The angled mixing bars 15 may improve mixing characteristics by assisting in the push of the catalyst material that is injected from the dasher rod through the center hole of the impeller. The mixing bars 15 may direct the catalyst outward radially toward the impeller arms 20 where the material is mixed at a faster rate. Without the mixing bars 15, the catalyst many spend more time in the center zone of the cartridge 1.

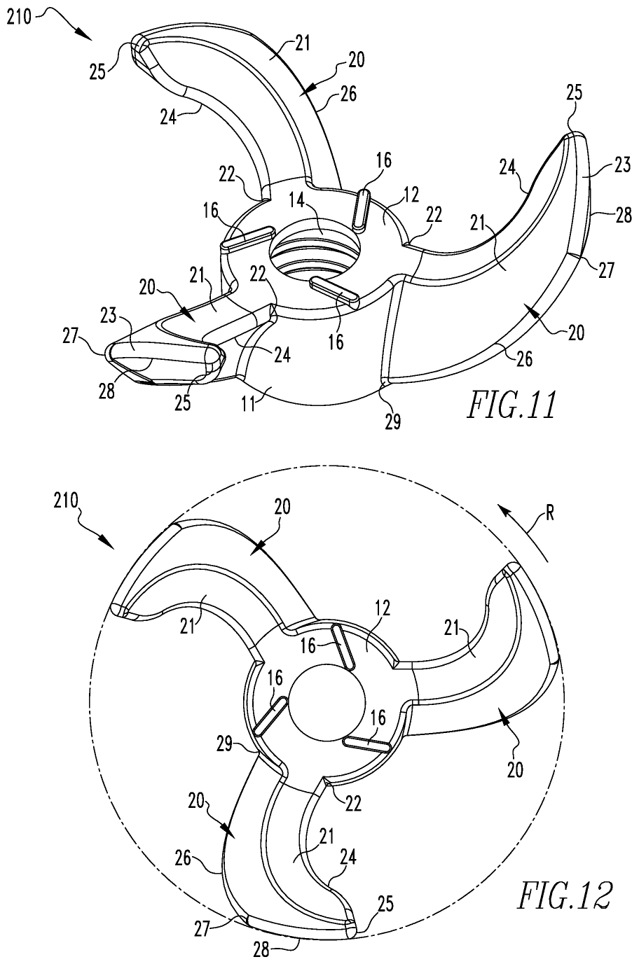

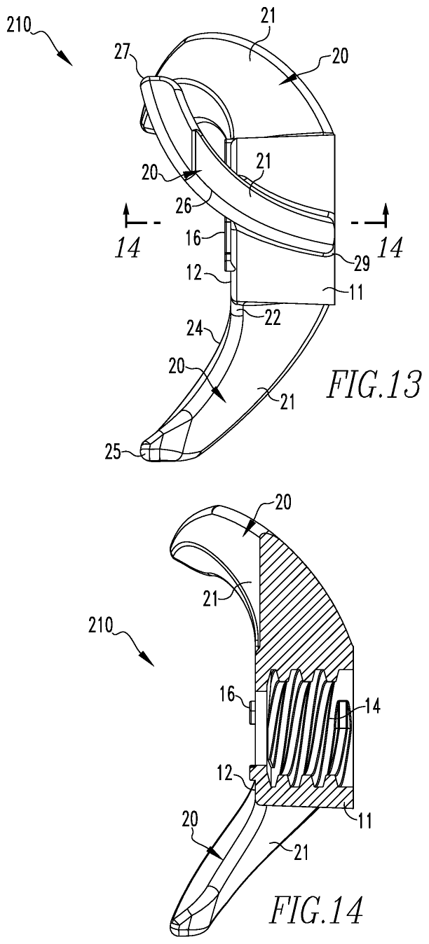

FIGS. 11-14 illustrate another mixing impeller 210 of the present invention. Each angled mixing bar 16 extends radially outward from the central hole of the hub 11 to the outer edge of the hub 11 at an angle in the same direction as the direction of rotation R of the mixing impeller 210. The angled mixing bars 16 may improve mixing characteristics in a similar fashion as mixing bars 15, but by pulling base material radially inward to facilitate faster mixing of base and catalyst together.

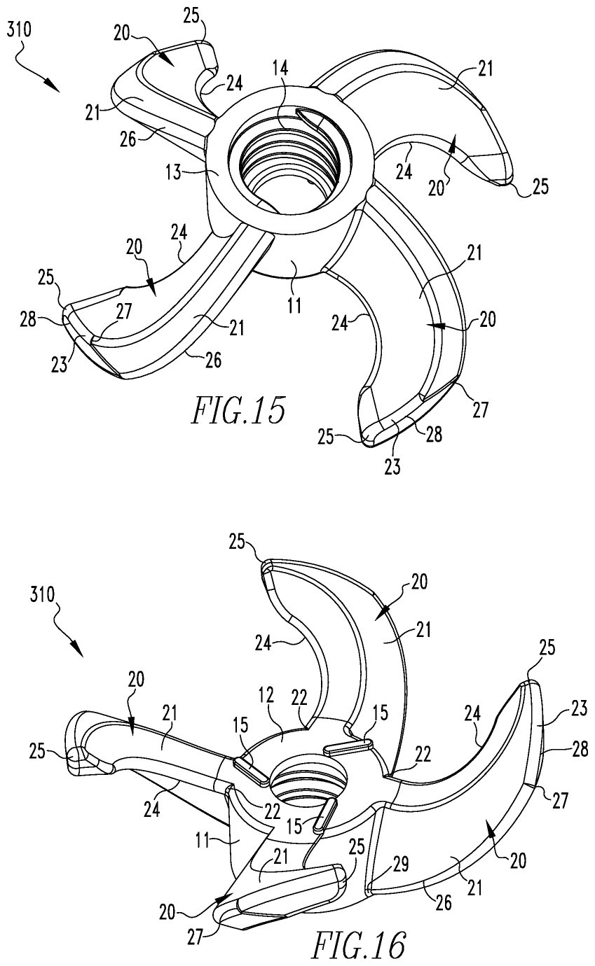

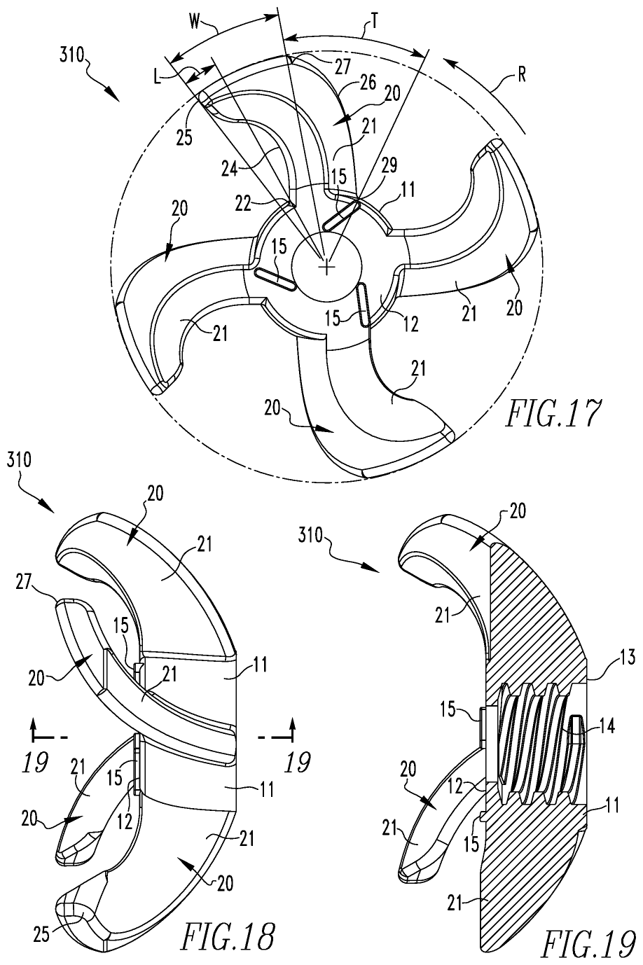

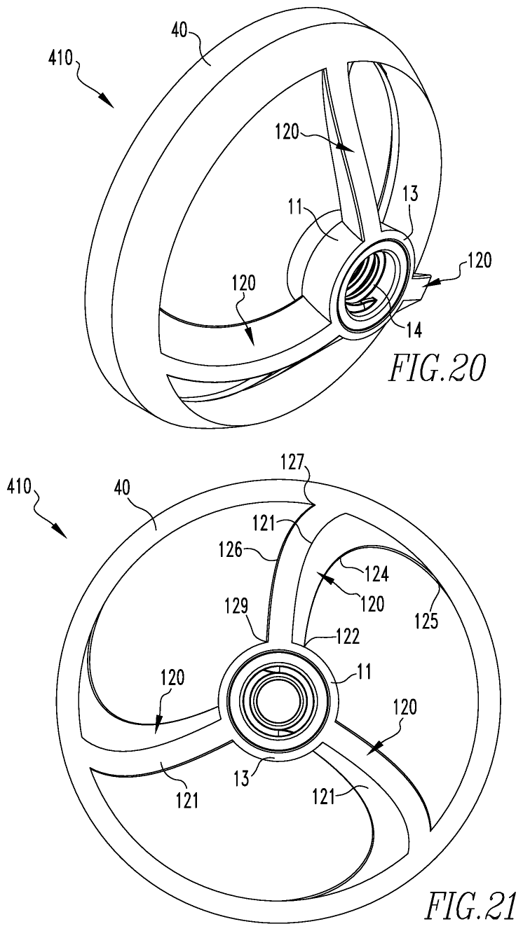

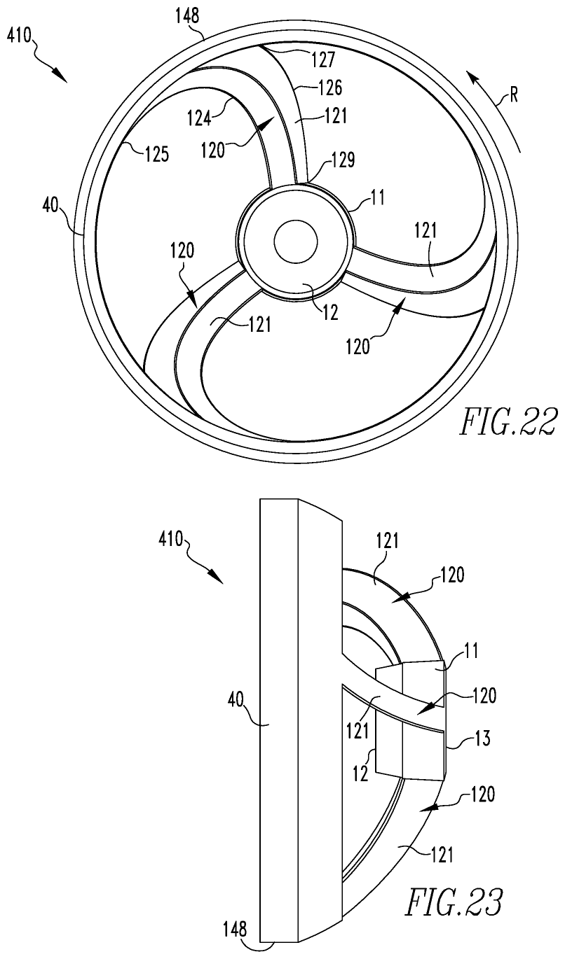

FIGS. 15-19 illustrate another mixing impeller 310 of the present invention. The mixing impeller 310 includes features similar to those previously described, except the mixing impeller 310 includes four mixing arms 20 rather than three mixing arms.

FIGS. 20-23 illustrate another mixing impeller 410 of the present invention. Similar to the mixing impellers previously described, the mixing impeller 410 shown in FIGS. 20-23 includes a central hub 11 having a top face 12 and a bottom face 13. Three mixing arms 120 extend from the central hub 11. Each mixing arm 120 includes a body portion 121, a concave leading edge 124 and a convex trailing edge 126. An outer ring 40 surrounds the mixing impeller 410 and is connected to the ends of each of the mixing arms 120. The outer ring 40 has an outer diameter surface 148 that fits within the cartridge 1 with a desired clearance or tolerance. A leading edge base fillet 122 is provided at the intersection between the leading edge 124 of each arm 120 and the hub 11. A trailing edge base fillet 129 is provided at the intersection of the trailing edge 126 of each arm 120 and the hub 11. The leading edge 124 terminates at its radial outermost portion with a leading tip or transition 125 that blends into an inner diameter surface of the outer ring 40. The trailing edge 126 terminates at its radial outermost point at a trailing edge transition 127 at the point of intersection with the inner diameter surface of the outer ring 40. During mixing operations, the presence of the outer ring 40 may provide support for cartridges that employ the use of a barrier style sealant or adhesive cartridge. In these cases, the base and catalyst may both be stored in the cartridge body, rather than catalyst in the dasher rod for injection style sealant kits. A barrier such as a disk-shaped sheet of aluminum foil, biaxially-oriented polyethylene terephthalate (Mylar), or other high barrier materials (not shown) may be held in place on the outer ring 40 of the impeller. The sealant material may be blended in a similar fashion to the previously described impellers without outer support rings.

The present impellers may dispense catalyst more uniformly throughout cartridges during mixing processes. More homogeneous sealant mixtures that cure consistently with less quality problems may be achieved. The amount of mixing time and number of strokes required to completely mix may be reduced. Furthermore, lower temperatures and reduced air entrapment inside the cartridge after the mixing process may be achieved.

Mixing characteristics of the present mixing impellers may be evaluated by the following test procedures. Visually inspect mixed sealant for flow lines caused by non-homogeneous mixing; sealant discoloration; and perform Shore A hardness checks at different points on cured samples and conduct tensile strength, elongation and ultimate hardness testing. Test variations for selected impeller types may include: manual injection of catalyst using standard instructions; mixing for 30 strokes, 45 strokes, and 60 strokes; manual injection of 100% catalyst near cartridge plunger; and mixing for 45 strokes and 60 strokes; manual injection of 100% catalyst near cartridge dome; and mixing for 45 strokes and 60 strokes; pull dasher rod down to dome side; and allow mixed cartridges to cure overnight inside the cartridge. Observation points may include: visual inspection of mixed sealant for flow lines caused by non-homogeneous mixing; sealant discoloration; and Shore A hardness checks at different points on the cured samples. Mixing impellers of the present invention may mix visually well after 60 stokes, but may fully mix at 45 strokes, with consistent Shore A hardness readings.

For purposes of the description above, it is to be understood that the invention may assume various alternative variations and step sequences except where expressly specified to the contrary. Moreover, other than in any operating examples, or where otherwise indicated, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

Whereas particular embodiments of this invention have been described above for purposes of illustration, it will be evident to those skilled in the art that numerous variations of the details of the present invention may be made without departing from the invention as defined in the appended claims.

What is claimed is:

1. A mixing impeller for mixing a sealant inside a cartridge, the mixing impeller comprising:
a central hub; and
at least two mixing arms extending radially outward from the central hub, wherein each of the mixing arms includes:
a leading edge;
a trailing edge; and
a wiping edge extending circumferentially between a leading tip of the leading edge and a trailing edge transition of the trailing edge, wherein the wiping edge has an arc length defining a wiping edge angle W, the leading tip is circumferentially offset in a direction of rotation of the mixing impeller defining a leading edge angle L, and a ratio of W:L is greater than 1:1.

2. The mixing impeller of claim 1, wherein the leading edge is concave.

3. The mixing impeller of claim 2, wherein the trailing edge is convex.

4. The mixing impeller of claim 3, wherein the concave leading edge has a radius of curvature along at least a portion thereof that is less than a radius of the mixing impeller.

5. The mixing impeller of claim 3, wherein the convex trailing edge has a radius of curvature along at least a portion thereof that is less than a radius of the mixing impeller.

6. The mixing impeller of claim 5, wherein the convex trailing edge has a radius of curvature along a portion thereof that is greater than the radius of the mixing impeller.

7. The mixing impeller of claim 1, wherein the ratio of W:L is greater than 1.5:1.

8. The mixing impeller of claim 1, wherein the ratio of W:L is from 1.1:1 to 10:1.

9. The mixing impeller of claim 1, wherein the trailing edge transition is circumferentially offset in the direction of rotation of the mixing impeller defining a trailing edge angle T.

10. The mixing impeller of claim 9, wherein a ratio of T:L is greater than 1:1.

11. The mixing impeller of claim 9, wherein the ratio of T:L is from 1.1:1 to 10:1.

12. The mixing impeller of claim 9, wherein a ratio of W:T is from 1:2 to 2:1.

13. The mixing impeller of claim 9, wherein W is from 10° to 40°, L is from 2° to 15°, and T is from 10° to 40°.

14. The mixing impeller of claim 1, wherein the mixing impeller comprises three of the mixing arms.

15. The mixing impeller of claim 1, wherein the mixing impeller comprises four of the mixing arms.

16. The mixing impeller of claim 1, further comprising an outer annular ring connecting the at least two mixing arms together.

17. The mixing impeller of claim 1, comprising at least one mixing bar extending axially outward from the central hub in an axial direction of the mixing impeller.

18. A mixing impeller for mixing a sealant inside a cartridge, the mixing impeller comprising:
a central hub; and
at least two mixing arms extending radially outward from the central hub, wherein each of the mixing arms includes:
a leading edge with a leading tip at a radial outermost portion thereof;
a trailing edge with a trailing edge transition at a radial outermost position thereof; and
a mixing arm tip between the leading tip and the trailing edge transition, wherein the mixing arm tip has a thickness measured along an axial direction of the mixing impeller that is less than an arc length of the mixing arm tip measured from the leading tip to the trailing edge transition.

19. A sealant cartridge and mixing impeller assembly comprising:
a generally cylindrical sealant mixing cartridge; and
a mixing impeller inside the sealant mixing cartridge, wherein the mixing impeller comprises:
a central hub; and
at least two mixing arms extending radially outward from the central hub, wherein each of the mixing arms includes:
a leading edge;
a trailing edge; and
a wiping edge extending circumferentially between a leading tip of the leading edge and a trailing edge transition of the trailing edge, wherein the wiping edge has an arc length defining a wiping edge angle W, the leading tip is circumferentially offset in a direction of rotation of the mixing impeller defining a leading edge angle L, and a ratio of W:L is greater than 1:1.

20. The sealant cartridge and mixing impeller assembly of claim 19, wherein the sealant mixing cartridge comprises a domed lower end and the assembly further comprises a plunger with a dome-shaped interior surface inserted in an upper end of the sealant cartridge, and wherein the at least two mixing arms of the mixing impeller are curved in an axial direction of the sealant cartridge to substantially match the domed lower end of the sealant cartridge and the dome-shaped interior surface of the upper plunger.
